(19) United States
(12) Patent Application Publication
(10) Pub. No.: US 2025/0133581 A1
(43) Pub. Date: Apr. 24, 2025

(54) METHODS AND APPARATUS FOR SIDELINK COMMUNICATIONS ON UNLICENSED SPECTRUM

(71) Applicant: MediaTek Singapore Pte. Ltd., Singapore (SG)

(72) Inventors: Junqiang CHENG, Beijing (CN); Tao CHEN, Beijing (CN); Min LEI, Beijing (CN)

(21) Appl. No.: 18/835,783

(22) PCT Filed: Feb. 10, 2023
(86) PCT No.: PCT/CN2023/075453

§ 371 Date: Aug. 5, 2024

(30) Foreign Application Priority Data
Feb. 11, 2022 (WO) PCT/CN2022/076034
Feb. 2, 2023 (CN) 202310093447.7

(51) Int. Cl. H04W 72/40; H04L 27/26; H04W 76/38

(52) U.S. Cl. CPC H04W 72/40; H04L 27/2607; H04W 76/38

(57) ABSTRACT

Apparatus and methods are provided for sidelink resource selection in unlicensed frequency bands. In one novel aspect, a combination of SL resource selection procedure and a listen-before-talk (LBT) procedure are used for resource selection in unlicensed frequency bands. In one embodiment, the LBT procedure is performed before the SL resource selection procedure. In one embodiment, a protection gap between the potential success of the LBT procedure and a starting position of candidate resources is dynamically configured. In another embodiment, a self-defer mechanism is performed in a protection gap between a success of the LBT procedure and the transceiving of the SL packets, including using a cyclic prefix (CP) extension and a timing advance (TA) to align the boundary of LBT success and transceiving, or performing a second LBT immediately before the transceiving of the SL packets. In yet another embodiment, one or more reserved candidate resources within the COT can be shared to other UE(s).

### TECHNICAL FIELD

The disclosed embodiments relate generally to wireless communication, and, more particularly, to sidelink communication on unlicensed spectrum.

### BACKGROUND

With the development and availability of 5G fast expanding worldwide, the demand of wireless data traffic is continually increasing, which in turn will require the availability of more spectrum to improve the capacity of future wireless communication systems. Therefore, the utilization of unlicensed spectrum including 2.4 GHz, 5 GHZ, and 60 GHz has drawn a lot of attention from both the academic and industry, which further motivates the successful development of LTE licensed assisted access (LAA) communication and 5G NR unlicensed (NR-U) communication in 3GPP. These unlicensed radio access technologies (RATs) can be regarded as an effective supplement to the licensed communications, and further alleviate the increasing demand of data traffic.

Sidelink is originally introduced as the device-to-device (D2D) communications in 3GPP Release 12 to enable direct transmissions between two devices without the data going through the network. Subsequently, sidelink technology is further extended to involve the scopes of LTE based vehicle-to-everything (V2X), and/or cellular V2X (C-V2X), and/or NR based V2X. The critical role and application of sidelink technology in LTE and NR have made it an inevitable remedy to support numerous use cases in the future wireless communication systems. Based on the above observations, for the development of beyond 5G (B5G) and future 6G communication technology, the research and design of sidelink communication on unlicensed spectrum (SL-U) is regarded as one of the most promising directions of the further sidelink enhancement and evolution. For the design of SL-U, one of the most critical issues is the harmonious and fair coexistence among the sidelink and other incumbents that operated on the same band, such as Wi-Fi and NR-U.

Improvements and enhancements are required for sidelink resource allocation in unlicensed frequency bands to ensure harmonious coexistence with other RATs.

### SUMMARY

Apparatus and methods are provided for sidelink resource selection in unlicensed frequency bands. In one novel aspect, a combination of SL resource selection procedure and a listen-before-talk (LBT) procedure are used for resource selection in unlicensed frequency bands. In one embodiment, the LBT procedure is performed before the SL resource selection procedure. In one embodiment, a resource gap between a potential success of the LBT procedure and a starting position of candidate resources is (pre-)configured or dynamically indicated based on one or more factors comprising a channel status, a layer1 priority, a CAPC value, and an overbooking resource size. In another embodiment, a self-defer mechanism is performed in a protection gap between a success of the LBT procedure and the transceiving of the SL packets. The self-defer mechanism is performed when SL packets are not ready when the LBT succeeds; and when the SL packets become ready, a second short LBT is performed immediately before the SL packets transceiving. The self-defer mechanism is performed when SL packets are ready when the LBT succeeds and when the protection gap is larger than a preconfigured threshold; and a second short LBT is performed immediately before the SL packets transceiving. A cyclic prefix (CP) extension (CPE) or a CPE and a timing advance (TA) is used to align a protection gap between a success of the LBT procedure and the transceiving of the SL packets when the SL packets are ready when the LBT succeeds and the protection gap is smaller than or equal to a preconfigured threshold. In yet another embodiment, a channel occupancy time (COT) is initiated after a success of the LBT procedure, and wherein one or more reserved candidate resources within the COT are shared to another UE.

This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1A illustrates a schematic system diagram illustrating an exemplary wireless network for sidelink data communication in unlicensed frequency bands with other coexistence RATs in accordance with embodiments of the current invention.

FIG. 1B illustrates exemplary flow diagrams for sidelink communication on unlicensed spectrum with LBT sensing and selection in accordance with embodiments of the current invention.

FIG. 2 illustrates an exemplary diagram with aperiodic data transmission in the unlicensed bands with dynamically configured parameters in accordance with embodiments of the current invention.

FIG. 3 illustrates an exemplary diagram with periodic data transmission in the unlicensed bands with dynamically configured parameters in accordance with embodiments of the current invention.

FIG. 4 illustrates exemplary diagrams for sharing the resources within a COT by different UEs in accordance with embodiments of the current invention.

FIG. 5 illustrates exemplary diagrams of performing LBT to initiate COT and in between transmissions in accordance with embodiment of the current invention.

FIG. 6 illustrates exemplary diagrams for the sidelink resource selection on unlicensed frequency bands with dynamical configurations for LBT procedure and SL selection procedure in accordance with embodiments of the current invention.

FIG. 7 illustrates an exemplary flow chart for the sidelink resource selection on unlicensed frequency bands in accordance with embodiments of the current invention.

### DETAILED DESCRIPTION

Reference will now be made in detail to some embodiments of the invention, examples of which are illustrated in the accompanying drawings.

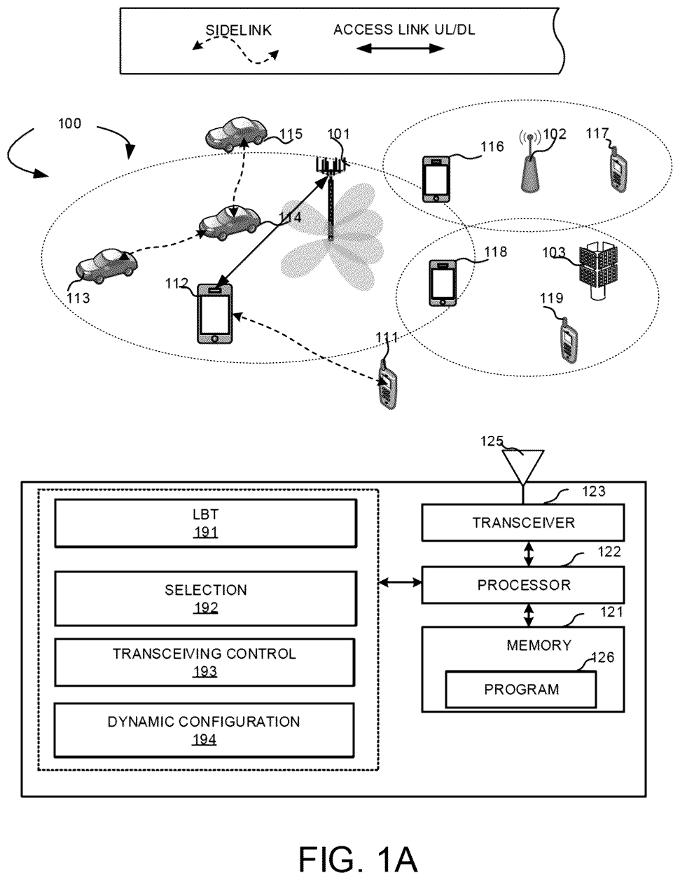

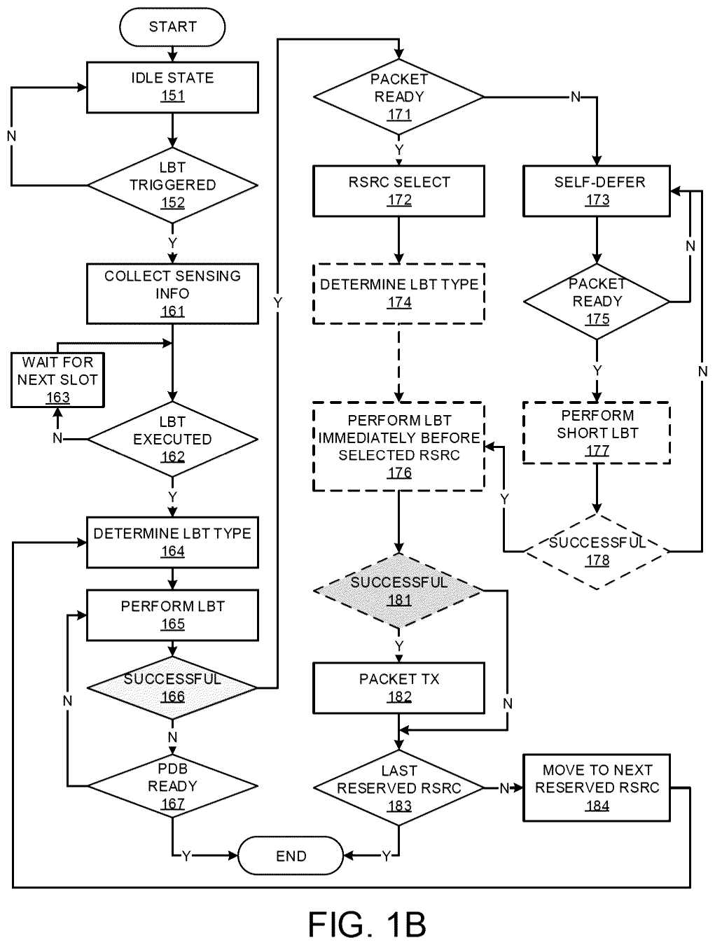

FIG. 1A is a schematic system diagram illustrating an exemplary wireless network for sidelink data communication in unlicensed frequency bands with other coexistence RATs in accordance with embodiments of the current invention. Wireless network 100 includes multiple communication devices or mobile stations, such as user equipments (UEs) 111, 112, 113, 114, and 115, which are configured with sidelink in unlicensed frequency bands. The exemplary mobile devices in wireless network 100 have sidelink capabilities. Sidelink communications refer to the direct communications between terminal nodes or UEs without the data going through the network. For example, UE 113 communicates with UE 114 directly without going through links with the network units. The scope of sidelink transmission also supports UE-to-network relay to extend the service range of an eNB, where the inter-coverage UE acts as the relay node between an eNB and an out-of-coverage UE. For example, UE 112 is connected with base station 101 through an access link. UE 112 provides network access for out-of-coverage UE 111 through sidelink relay. The base station, such as base station 101, may also be referred to as an access point, an access terminal, a base station, a Node-B, an eNode-B (eNB), a gNB, or by other terminology used in the art. The network can be a homogeneous network or heterogeneous network, which can be deployed with the same frequency or different frequencies. Base station 101 is an exemplary base station. With the demands for more capacity and the development of sidelink communication, it is important for the sidelink devices to use the unlicensed frequency bands and be harmoniously coexistence with devices with other RATs operating in the same unlicensed frequency bands. For example, neighboring UEs 116 and 117 communicate with base station 102 through other RATs, such as Wi-Fi, sharing the same unlicensed frequency band. Neighboring UEs 118 and 119 communicate with base station 103 through other RATs, such as NR, sharing the same unlicensed frequency band.

For sidelink transmissions on the unlicensed spectrum (SL-U), efficient resource allocation is one of the most critical issues to ensure the fair coexistence with other RATs operated in the unlicensed spectrum, such as NR-U and Wi-Fi, etc. Two modes of resource allocation schemes are identified for NR sidelink. The first one is named Mode-1, while the second is Mode-2. For Mode-1, the resource allocation is scheduled by the gNB using the Uu interface. This mode is only suitable for the sidelink UEs in network coverage. For Mode-2, the sidelink UE can autonomously select the resources from a (pre-)configured resource pool(s) based on the channel sensing mechanism over PC5 interface. In this case, the sidelink UEs can operate both under in-coverage and out-of-coverage. When a transmitting sidelink UE attempts to select/reserve resources with Mode-2, it should conduct the resource selection/reservation procedures, which include two stages: resource sensing and resource selection/reservation. Generally, in the resource sensing stage, to avoid causing interference to the existing sidelink transmissions operated by other sidelink UEs, the candidate resources potentially available for the sidelink transceiving are identified. Next, in the resource selection stage, the sidelink UE can select the candidate resources used for transmission block (TB) transmission with the assistance of the sensing results. In one novel aspect, listen before talk (LBT) is used in the selection stage for the unlicensed frequency bands resources. LBT is a spectrum sharing technology by which a device must perform the clear channel assessment (CCA) check before it starts a transmission. Empowered by the LBT mechanism, it is possible for multiple UEs to share a channel, and fair coexistence among different RATs can be guaranteed. In one novel aspect, the combination design of sidelink sensing and LBT is provided for a resource allocation scheme to ensure the harmonious coexistence among sidelink and other wireless systems.

FIG. 1A further illustrates simplified block diagrams of a mobile device/UE for operating in the unlicensed frequency band. UE 111 is an example. UE 111 has an antenna 125, which transmits and receives radio signals. An RF transceiver circuit 123, coupled with the antenna, receives RF signals from antenna 125, converts them to baseband signals, and sends them to processor 122. In one embodiment, the RF transceiver may comprise two RF modules (not shown). RF transceiver 123 also converts received baseband signals from processor 122, converts them to RF signals, and sends out to antenna 125. Processor 122 processes the received baseband signals and invokes different functional modules to perform features in UE 111. Memory 121 stores program instructions and data 126 to control the operations of UE 111. Antenna 125 sends uplink transmission and receives downlink transmissions to/from base stations.

UE 111 also includes a set of control modules that carry out functional tasks. These control modules can be implemented by circuits, software, firmware, or a combination of them. An LBT module 191 performs a LBT procedure to prepare for a UE sidelink (SL) transceiving in unlicensed frequency bands, wherein the LBT procedure determines channel selection with other coexisting wireless system in the unlicensed frequency bands. A selection module 192 performs sidelink (SL) resource selection procedure, wherein the SL resource selection procedure selects candidate resources in the unlicensed frequency bands for an SL transceiving for the UE. A transceiving controller 193 transmits and receives SL packets on the selected candidate resources when both the SL resource selection procedure and the LBT procedure succeed. A dynamic configuration module 194 dynamically configures parameters for the LBT procedure and the SL selection procedure.

FIG. 1B illustrates exemplary flow diagrams for sidelink communication on unlicensed spectrum with LBT sensing and selection in accordance with embodiments of the current invention. In one novel aspect, the SL resource selection in the unlicensed frequency bands uses the combination of SL resources selection procedure and channel access, such as the LBT procedure. The independent and asynchronous sidelink sensing is performed by each sidelink device to collect the sensing information of the unlicensed spectrum, which can then be used to assist the channel access (LBT) procedures after channel access (LBT) is triggered, and also can be used to assist the following sidelink selection/reservation procedures after the channel access (LBT) is successful and the packet arrives.

At step 151, the UE is in the IDLE state. When a sidelink UE is not transmitting, it keeps sensing the unlicensed channel resources in order to identify the available candidate resources. At step 152, the UE determines whether the LBT can be triggered. In one embodiment, the LBT trigger time to start performing the LBT procedure is dynamically configured. In one embodiment, the LBT is triggered when the new data packets arrive or is ready to transmit. In another embodiment, the SL data packets are periodic traffic and the LBT procedure is performed before the SL packets arrival or is ready to transmit. The trigger time is (pre-)configured or dynamically indicated based on one or more trigger factors comprising a failure probability of the LBT procedure, channel loading status information, CAPC value and channel congestion control information.

At step 161, the UE collects sensing information. During the sensing procedure, the sidelink UE decodes the 1^{st}-stage SCI from other sidelink UEs on the unlicensed channel. By decoding the 1^{st}-stage SCI, the sidelink UE can know the resources that have been reserved by other sidelink UEs for their TB initial transmission and re-transmission(s). During the sensing procedure, the sidelink UE also measures the sidelink reference signal received power (RSRP) of the transmission from other sidelink UEs. The information element (IE) sl-RS-ForSensing from a higher layer indicates whether the RSRP of physical sidelink control channel (PSCCH) or RSRP of PSSCH is measured. The RSRP can be measured by the demodulation reference signal (DMRS) of physical sidelink control channel (PSCCH), and/or measured by the DMRS of physical sidelink shared channel (PSSCH). This sensing information, including the 1^{st}-stage SCI and RSRP, is stored by the sidelink UE, and will be used in the following resource selection procedure. At the system level, each sidelink device may perform independent and asynchronous sensing mechanism to collect the sensing information of the unlicensed spectrum.

When a sidelink device wants to access the unlicensed spectrum, at step 162, the device determines whether the LBT procedure can be performed/executed. A random back-off counter generation time and the channel access (LBT) trigger time can be indicated/configured separately and dynamically. In an aspect of the disclosure, to combat the potential channel access (LBT) failure, the generation time of the random back-off counter in channel access (LBT) and the trigger time of channel access (LBT) can be indicated/configured separately and dynamically. For example, the random back-off counter generation time and LBT trigger time can be (pre-)configured or indicated as soon as the packet is ready or after the packet is ready, and until the packet delay budget (PDB) arrives. In another embodiment, if the packet is periodic, the random back-off counter generation time and LBT trigger time can be indicated/configured before the packet is ready and can depend on one or more trigger factors including the channel access (LBT) failure probability (e.g., derived/determined based on the ratio of the failure times over the total times for channel access (LBT) sensing in the past X ms/slots, or the consecutive number of channel access (LBT) failure times), the channel loading status information, the CAPC value, and the channel congestion control information. For example, LBT can be performed in the earlier time if the channel is more congested (e.g., SL Channel Busy Ratio (CBR) is high or LBT failure ratio is high). Otherwise, it can be performed at a later time. That is, the (earliest) time to perform LBT for potential data transmission can be a function of one or more trigger factors including the channel status, the priority of data/channel, and the QoS.

If step 162 determines no, the sidelink device/UE moves to step 163 and waits for the next slot. If step 162 determines yes, the UE performs LBT or channel access, accordingly. In one embodiment, at step 164, the UE first determines the type of LBT procedure to be performed. In one embodiment, the LBT procedure initiates a channel occupancy time (COT). If the LBT is used to initiate a COT or the LBT is out of the COT, Type-1 LBT is configured. If the LBT is used within an initiated/shared COT, the LBT type is (pre-) configured from Type-2A LBT, Type-2B LBT and Type-2C LBT. At step 165, LBT procedure is performed. At step 166, the UE determines whether the LBT is successful.

At step 166, the UE determines if the LBT is successful. If step 166 determines the LBT is unsuccessful, the UE moves to step 167 and determines whether the PDB has arrived. If step 167 determines yes, the procedure is ended. If step 167 determines no, the UE moves to step 165 and performs another LBT.

If step 166 determines that the LBT is successful, the UE performs SL resource selection procedure. Only when the channel access (LBT) is successful, which indicates the sensed unlicensed spectrum is idle, the device can occupy the corresponding channels for a period, i.e., the COT. Within the COT, the SL-U device performs the sidelink resource selection/reservation procedures based on the sensing information to select/reserve resources for the current or next traffic (re-)transmission. Besides, the COT can be used by the initiating device/cluster header only, and can also be shared with the responding device or the other devices in the group.

At step 171, the UE determines if the packet has been arrived or ready. If step 171 determines yes, the UE moves to step 172 and selects the SL resource through the SL resource selection procedure. In one embodiment, a LBT is performed before the transmission of the SL packets. At step 174, the UE determines the LBT type. At step 176, the UE performs the LBT immediately before the selected resource for the SL transceiving.

If step 171 determines no, there is a protection gap between the successful LBT and the starting position of the selected SL resource. In one embodiment, at step 173, a self-defer mechanism is performed in the protection gap between the success of the LBT procedure and the transceiving of the SL packets. Immediately before the resource selection/reservation, the UE executes a relatively simpler/shorter channel access (LBT) mechanism to initiate a COT. If the gap is no more than some time (e.g., one symbol for all SCS cases or 1/2/4 symbol(s) for 15/30/60 kHz SCS, respectively), the device can utilize the cyclic prefix (CP) extension and timing advance (TA) to align the boundary between channel access (LBT) successful time and resource selection/reservation time. Empowered by this scheme, the SL-U device can be configured with more time and/or chances to try channel access (LBT), which further leads to an increased success probability of channel access (LBT). At step 175, after the self-defer, the UE determines if the packet has been ready. If step 175 determines no, the UE moves to step 173 and performs further self-defer. If step 175 determines yes, in one embodiment, the UE moves to step 177 and performs a short LBT. At step 178, the UE determines if the short LBT is successful. If step 178 determines yes, the UE moves to step 176 to perform an LBT immediately before the selected SL resource. If step 178 determines no, the UE moves back to step 173 and performs self-defer. At step 181, the UE determines if the LBT before the reserved SL resource is successful. If step 181 determines yes, the UE moves to step 182 and performs SL packets transceiving. At step 183, the UE determines if this is the last reserved SL resource. If step 183 determines yes, the procedure is ended. If step 183 determines no, the UE, at step 184, moves to the next reserved resource, and subsequently, moves to step 164 to determine a LBT type to be performed for the transceiving on the next reserved resource. If step 181 determines no, no SL packets are transmitted and the UE moves to step 183 to see if there are more reserved resources.

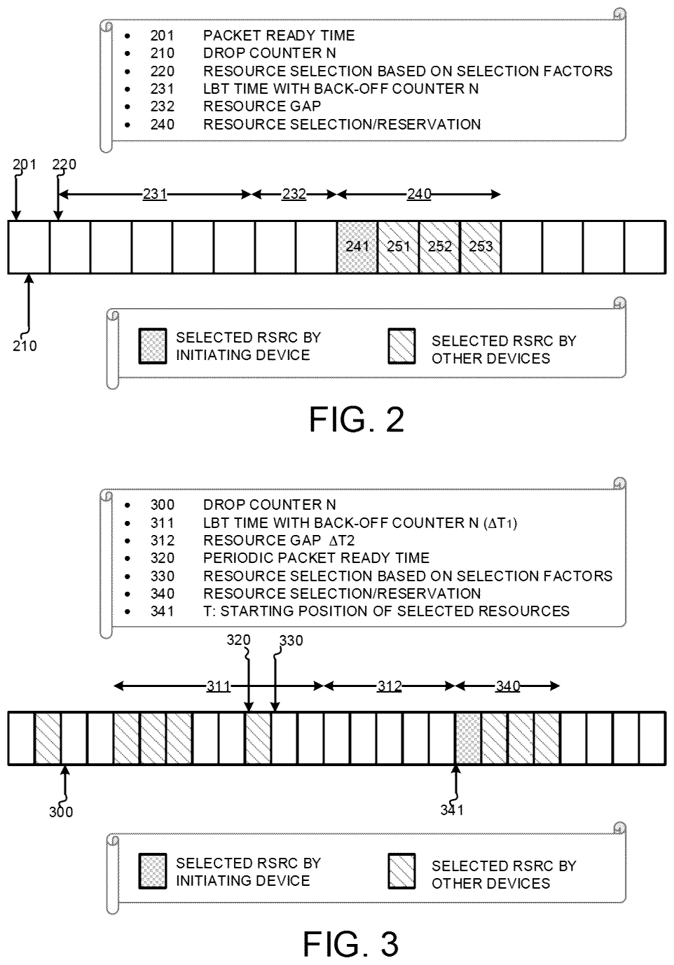

In one novel aspect, to combat the potential channel access (LBT) failure, the generation time of the random back-off counter and the trigger time of channel access (LBT) can be configured dynamically. For both the aperiodic and periodic traffics, the generation time of the random back-off counter and the trigger time of channel access (LBT) can be configured after and/or as soon as the packet is ready, and until the PDB arrives. For periodic traffic, the LBT can be configured before the packets is ready. FIG. 2 and FIG. 3 illustrate exemplary procedures for periodic and aperiodic traffics.

FIG. 2 illustrates an exemplary diagram with aperiodic data transmission in the unlicensed bands with dynamically configured parameters in accordance with embodiments of the current invention. At step 201, the aperiodic traffic arrives and/or is ready. After the packet arrives and/or is ready, at step 210, the random back-off counter N can be first generated according to the CAPC and/or QoS of the packet type. Subsequently, at step 220, the resource selection based on the LBT counter for LBT Type-1 is triggered. Period 231 is the LBT time with back-off counter N. A protection gap 232 between the channel access (LBT) successful position and the resource selection/reservation position can be configured to combat the potential LBT failure. If the channel access (LBT) is successful, at step 240, the device can start the resource selection/reservation procedures in the initiated COT. During this procedure, the resource can be over-booked to combat the potential LBT failure. The UE selects one or more candidate resources during 240. In some scenarios, the candidate resources may be selected by other UEs, such as resource 251, 252 and 253. The UE selects resource 241 for the SL packets.

FIG. 3 illustrates an exemplary diagram with periodic data transmission in the unlicensed bands with dynamically configured parameters in accordance with embodiments of the current invention. If the traffic is periodic, the generation time of the random back-off counter and the trigger time of channel access (LBT) can be indicated/configured dynamically before the packet is ready. At step 300, before the periodic packet is ready, the random back-off counter N and the trigger time of channel access (LBT) can be first generated based on one or more trigger factors. The trigger factors include channel access (LBT) failure probability, the channel loading status information, channel congestion control information. In one embodiment, the LBT failure probability is derived/determined based on one or more factors including the ratio of the failure times over the total times for channel access (LBT) sensing in the past X ms/slots, and the consecutive number of channel access (LBT) failure times. For example, LBT can be performed in the earlier time if the channel is more congested (e.g., SL Channel Busy Ratio (CBR) is high or LBT failure ratio is high). Otherwise, it can be performed at the later time. In one embodiment, the earliest time to perform LBT for potential data transmission can be a function of one or more triggering factors including the channel status, the priority of data/channel, and the QoS.

In one embodiment, at step 300, before the periodic packet is ready to transmit, the random back-off counter N can be generated according to the pre-known CAPC and/or QoS of the packet type. The channel access (LBT) can be triggered with the random back-off counter before the periodic packet arrival or is ready to transmit. At step 320, the periodic packets is ready to transmit. At step 330, UE performs resource selection based on selection factors. For example, if the potential failure time of the basic sensing slot (e.g., 9 μs) is assumed as n, which can be related to the actual resource overbooking number, and/or the channel access (LBT) failure probability, and/or the channel loading status information, etc. If the selected/reserved resource position is assumed as T 341, and the original channel access (LBT) required time is assumed as ΔT₁ 311, which is related to the random back-off counter N. Then the original channel access (LBT) trigger time is T−ΔT₁. But with the proposed scheme, the channel access (LBT) trigger time can be configured ΔT₂ 312 earlier than the original channel access (LBT) trigger time, i.e., T−ΔT₁−ΔT₂, where ΔT₂=n×T_{d}, and T_{d} is the defer duration in the conventional channel access (LBT) procedures. After the channel access (LBT) is successful, the device can start the resource selection/reservation procedures in the initiated COT at step 340. In one embodiment, the resource overbooking scheme is configured during this procedure.

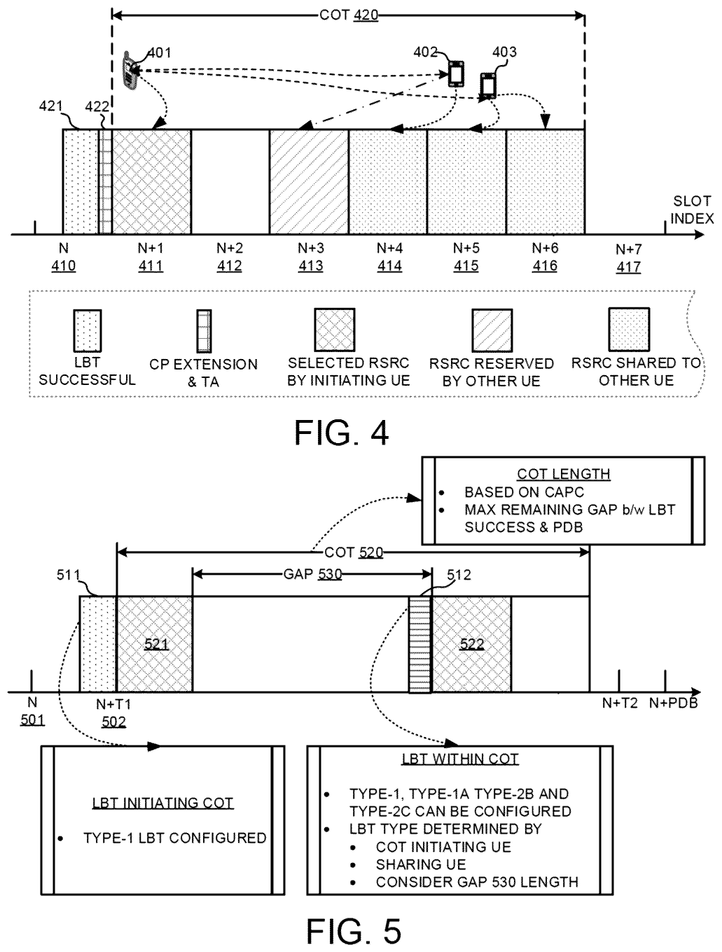

FIG. 4 illustrates exemplary diagrams for sharing the resources within a COT by different UEs in accordance with embodiments of the current invention. As an example, LBT 421 is performed at slot N 410. COT 420 is initiated, wherein resources N+1 411, N+2 412, N+3 413, N+4 414, N+5 415, and N+6 416 are within the COT. Resource N+7 417 is outside of COT 420. In some scenarios, there is a protection gap between the success of the LBT 421 and the initial position of the selected resource, which is N+1 411. In one embodiment, a self-defer mechanism is performed when the protection gap exists. In one embodiment, when the gap is smaller than or equal to a predefined value, such as one symbol, the self-defer mechanism is to use a cyclic prefix (CP) extension to align the protection gap. In another embodiment, the self-defer mechanism is to use a CP extension and timing advance (TA) 422 to align the protection gap. In yet another embodiment, when the gap is greater than a predefined value, the self-defer mechanism is to perform a second LBT immediately before the transceiving of the SL packets. The UE selects N+1 411 for the SL packets. In one embodiment, one or more reserved candidate resources within the COT are shared to one or more other UEs. Resources 414, 415, and 416 are shared to one or more other UEs. In one embodiment, the initiating device or the cluster header can share the remaining idle and/or used resources within the COT to the responding device for their ACK or NACK transmission in the COT if a physical sidelink feedback channel (PSFCH) is configured or preconfigured. In another embodiment, the initiating device or cluster header can also share the idle or unused resources within the COT to the responding device and/or the other devices in the group for their data traffic transmission. In yet another embodiment, COT specific PSFCH resources configuration can be provided by configuration, pre-configuration or the initiating device/cluster header.

In one novel aspect, the initiated COT is shared to the responding devices and/or the other devices in the group. An initiating UE 401 and other exemplary UEs 402 and 403 are operating in the unlicensed bands. Initiating UE 401 can also be a cluster header in the group with UE 402 and UE 403. As an example, resource 413 is reserved by UE 402. In one embodiment, the initiating device/cluster header can share the resources reserved by the other sidelink devices to the corresponding sidelink devices for their current and/or the next packet (re-)transmission. In one embodiment, during the resource selection/reservation procedures, the initiating device or the cluster header may exclude or skip the resources reserved by the other sidelink devices based on one or more reserved resource sharing factors comprising priority level, CAPC value, destination ID, and channel/transmission type on the reserved resource, such as resource 413. These excluded resources can be shared to the corresponding sidelink devices for their current and/or next TB transmission or retransmission. When LBT 421 is successful, COT 420 is initiated. UE 401 performs SL resource selection. In one embodiment, the SL resource selection procedure within COT 420 skips the reserved resources, such as resource 413. UE 401 selects resource 411. In one embodiment, UE 401 may share the resource within COT 420 to one or more other UEs. UE 401 may share resource 413 and 414 to UE 402, and 415 and 416 to UE 403.

FIG. 5 illustrates exemplary diagrams of performing LBT to initiate COT and in between transmissions in accordance with embodiment of the current invention. In one embodiment, only when the channel access (LBT) is successful, the SL-U device can occupy the unlicensed spectrum in the following COT duration. After the COT is initiated, the COT information indicator, including COT location and COT duration, etc., should be delivered to the other devices in the group. At time 501 of slot n, the SL transceiving is triggered. LBT 511 is performed. After processing time T₁, at time 502, COT 520 is initiated. Upon the success of LBT 511, COT 520 is initiated. In one embodiment, as shown in FIG. 4, a protection gap may exist between LBT 511 and the transmission resource and a self-defer mechanism is used. The initiated COT can be used by the initiating device or the cluster header only. Within the COT 520, the COT initiating device, or the cluster header should execute the sidelink resource selection/reservation procedures in a selection window (SW) defined by the range of [n+T₁, n+T₂], where T₁ depends on the processing time and the gap configuration between the end of channel access (LBT) and the start of SW. The value of T₂ is left to the device implementation but should meet the range T_{2, min}≤T₂≤PDB, where T_{2,min} depends on the priority of the traffic and also the sub-carrier spacing (SCS). In one embodiment, the COT length of COT 520 after a successful Type 1 channel access (LBT) 511 can be determined by the channel access priority class (CAPC) of the packet being transmitted. In another embodiment, the length of the initiated COT 520 can also be configured according to the maximum remaining gap between the Type 1 channel access (LBT) successful time and the PDB time.

In one embodiment, in the selection window, the sidelink device performs two steps to select resources. The first step excludes some candidate resources in the selection window. The excluded resources include, for example, the resources related to the half-duplex operation, the resources reserved by other sidelink devices, etc. The later excluded resources can be determined based on the reservation information in the 1^{st}-stage SCI and the associated RSRP obtained from the sensing stage. After the first step, the second step in the selection/reservation procedure is randomly selecting M resources from the list of available resources after the first step. As an example, resources 521 and 522 are selected. In another embodiment, multi-consecutive-slot (MCSt) resources are selected.

For sidelink communication, the device can reserve resources for the current packet re-transmission and/or for the next packet (re-)transmission. This principle also applies to SL-U devices. For SL-U, one example is that the resources for the current packet retransmission and/or the next packet initial transmission and/or the next packet re-transmission can be selected/reserved within the current COT. For this case, the device should execute a channel access (LBT) procedure, such as LBT 512 before it can access the selected/reserved resources. The channel access (LBT) type for LBT 512 can be indicated/configured from Type 1 channel access (LBT), Type 2A channel access (LBT), Type 2B channel access (LBT) and Type 2C channel access (LBT). The type of channel access (LBT) can refer to 3GPP specification for NR-U.

In one embodiment, if the channel access (LBT) is used to initiate a COT or the channel access (LBT) is executed out of the COT, such as LBT 511, Type 1 channel access (LBT) can be indicated/configured. If the channel access (LBT) is executed within an initiated/shared COT, such as LBT 512, the channel access (LBT) type can be configured from Type 1 channel access (LBT), Type 2A channel access (LBT), Type 2B channel access (LBT) and Type 2C channel access (LBT). The channel access (LBT) type can be indicated/configured by the COT initiating device/cluster header and can also be determined by the COT sharing device according to the gap 530 between two consecutive transmissions.

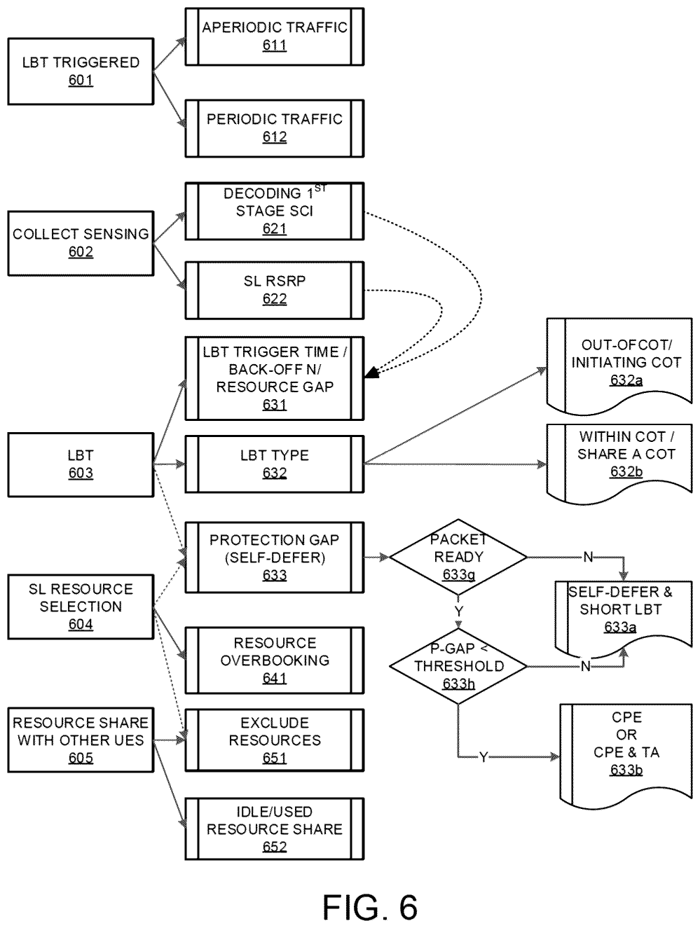

FIG. 6 illustrates exemplary diagrams for the sidelink resource selection on unlicensed frequency bands with dynamical configurations for LBT procedure and SL selection procedure in accordance with embodiments of the current invention. In one novel aspect, channel access, such as LBT, is triggered for SL transceiving in the unlicensed frequency bands. At step 601, LBT is triggered. The LBT can be triggered by aperiodic traffic 611. The random back-off counter generation time and LBT trigger time can be indicated/configured after and/or as soon as the packet arrives or is ready, and until the packet delay budget (PDB) arrives. The LBT can be triggered by a periodic traffic 612, where the LBT procedure is performed before the SL packets arrival or is ready to transmit, and wherein trigger time is (pre-)configured or dynamically indicated based on one or more trigger factors comprising a failure probability of the LBT procedure, channel loading status information, CAPC value and channel congestion control information.

When a sidelink device is not transmitting, it keeps sensing the unlicensed spectrum resources in order to collect the sensing information and further identify the available candidate resources. At step 602, the UE collects sensing information. The sensing information of the unlicensed spectrum includes the 1^{st}-stage sidelink channel information (SCI) 621, and the reference signal received power (RSRP) 622 from other sidelink devices. Specifically, during the sidelink sensing procedures, the sidelink device decodes the 1^{st}-stage SCI from other sidelink devices on the unlicensed spectrum. By this way, the sidelink device can obtain the resource assignment and resource reservation information of other devices. The sidelink device also measures the sidelink RSRP of the transmissions from other devices, which can further used to assist the channel access (LBT) and sidelink selection/reservation procedures. The information element (IE) sl-RS-ForSensing from higher layer indicates whether the RSRP of physical sidelink control channel (PSCCH) or RSRP of physical sidelink shared channel (PSSCH) is measured. Then if the resource (re-)selection/reservation is triggered at slot n, the sidelink device should first collect the sensing information in a certain period [n−T₀, n−T_{proc,0}], where T₀ is an integer defined in number of slot and equals to x ms (e.g., 1100 ms or 100 ms), which is determined by the higher layer IE sl-Sensing Window. Besides, T_{proc,0} is the time required to complete the sensing procedure. In one embodiment, the sensing information, including 621 and 622 can be used to assist the channel access (LBT) procedures 603. Specifically, during the sensing stage, the time/frequency resource assignment and the resource reservation information of other sidelink transmissions can be obtained after decoding the 1^{st}-stage SCI. Then the linear average of the reference signal power Pₜ₁ on the specific bandwidth can be calculated, i.e., the RSRP of the reference signal can be obtained in the sidelink sensing stage. Next, the total power Pₜ₂ on the entire allocated bandwidth, i.e., RSSI can be approximately calculated as Pₜ₂=Pₜ₁×N_{RE}+Pₙ+Pᵢ, where Pₙ and Pᵢ represent the power of noise and interference, respectively, and N_{RE} is the number of resource element, which is indicated in the 1^{st}-stage SCI. Next, if Pₜ₁ larger than a threshold Th₁, Pₜ₂ will be larger than a corresponding threshold Th₂. Assuming that the channel access (LBT) energy detection/sensing threshold is Th, if Th₂≥Th, then the channel access (LBT) does not need to be executed in at least the current slot, and the device should wait for the next slot, then conduct channel access (LBT) again with the assistance of the sensing information in the next slot. The sidelink device can derive the channel access (LBT) result in some cases, which can be used to avoid the LBT execution, and further reduce the power consumption of the devices.

In one novel aspect, the configuration parameters for LBT 603 can be dynamically configured, such as LBT trigger time, back-off counter N and resource gap 631. In one embodiment, an LBT trigger time to start performing the LBT procedure is dynamically configured. In another embodiment, a resource gap between a potential success of the LBT procedure and a starting position of candidate resources is dynamically configured based on one or more factors comprising a channel status, a layer priority, and an overbooking resource size. In one embodiment, the type of LBT 632 is determined dynamically. In one embodiment, LBT 632a is performed out-of-COT or outside COT or to initiate a COT. In another embodiment, LBT 632b is performed within COT or inside COT or to share a COT. In one embodiment 633, a self-defer mechanism is performed in a protection gap between a success of the LBT procedure and the transceiving of the SL packets. In one embodiment 633a, a self-defer mechanism is performed and a short second LBT is performed immediately before the packet transceiving. In another embodiment 633b, a cyclic prefix (CP) extension (CPE) or a CPE and a timing advance (TA) are used to align the protection gap. In particular, when the first LBT is successful, the UE determines, at step 633g, whether the packet is ready. If the packet is not ready, embodiment 633a is used when the self-defer is performed; and when the packet is ready, a short second LBT immediately before the SL packet transceiving. If step 633g determines yes, which means the packet is ready when the first LBT succeeded, the UE determines the length of the protection gap, which is the gap between the LBT success and the SL packet transceiving. If, at step 633h, the UE determines that the protection gap is smaller than or equal to a predefined threshold, the UE performs embodiment 633b, which is a CPE or a CPE & TA to align the protection gap. If step 633h determines no, which means the protection gap is larger than a predefined threshold, the UE performs embodiment 633a, which is performs the self-defer followed by a short second LBT immediately before the SL packet transceiving.

In one embodiment, SL resource selection 604 has dynamically configured parameters. In one embodiment 641, the candidate resource selected by the SL resource selection procedure has an overbooking resource size larger than a resource size required for the SL data transceiving. the overbooking resource size is dynamically configured based on one or more overbooking factors comprising a channel status, a layer priority, a CAPC value, channel/transmission type an LBT failure probability, channel loading status information, channel congestion control information and a gap between a potential success of the LBT procedure and a starting position of candidate resources.

In one embodiment 605, a COT is initiated after a success of the LBT procedure and one or more reserved candidate resources within the COT are shared to one or more other UEs. In one embodiment 651, the SL selection procedure within the COT first excludes one or more resources. In one embodiment, the excluded resources are reserved by other UEs. The initiating UE may share these excluded resources with other UEs. In one embodiment 652, the UE shares idle or used resources with other UEs.

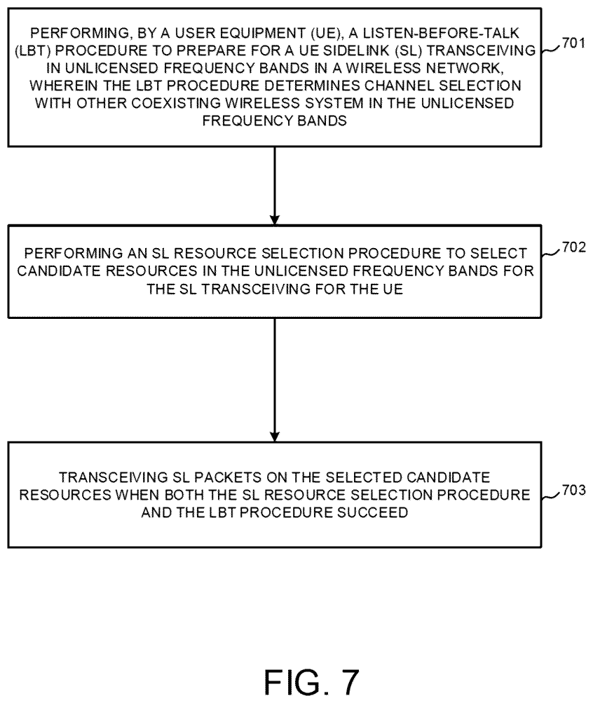

FIG. 7 illustrates an exemplary flow chart for the sidelink resource selection on unlicensed frequency bands in accordance with embodiments of the current invention. At step 701, the UE performs a listen-before-talk (LBT) procedure to prepare for a UE sidelink (SL) transceiving in unlicensed frequency bands in a wireless network, wherein the LBT procedure determines channel selection with other coexisting wireless system in the unlicensed frequency bands. At step 702, the UE performs an SL resource selection procedure to select candidate resources in the unlicensed frequency bands for the SL transceiving for the UE. At step 703, the UE transceives SL packets on the selected candidate resources when both the SL resource selection procedure and the LBT procedure succeed.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method, comprising:
performing, by a user equipment (UE), a listen-before-talk (LBT) procedure to prepare for a UE sidelink (SL) transceiving in unlicensed frequency bands in a wireless network, wherein the LBT procedure determines channel selection with other coexisting wireless system in the unlicensed frequency bands;
performing an SL resource selection procedure to select candidate resources in the unlicensed frequency bands for the SL transceiving for the UE; and
transceiving SL packets on the selected candidate resources when both the SL resource selection procedure and the LBT procedure succeed.

2. The method of claim 1, wherein the LBT procedure is performed before the SL resource selection procedure.

3. The method of claim 1, wherein an LBT trigger time to start performing the LBT procedure is dynamically configured.

4. The method of claim 3, wherein the LBT procedure is performed before the SL packets is ready, and wherein the LBT trigger time is preconfigured or dynamically indicated based on one or more trigger factors comprising a failure probability of the LBT procedure, channel loading status information, CAPC availability and channel congestion control information.

5. The method of claim 1, wherein a resource gap between a potential success of the LBT procedure and a starting position of candidate resources is preconfigured or dynamically indicated based on one or more resource gap factors comprising a channel status, a layer1 priority, a CAPC value, a channel/transmission type and an overbooking resource size.

6. The method of claim 1, wherein the candidate resource selected by the SL resource selection procedure has an overbooking resource size larger than a resource size required for the SL data transceiving.

7. The method of claim 6, wherein the overbooking resource size is preconfigured or dynamically indicated based on one or more overbooking factors comprising a channel status, a layer1 priority, an LBT failure probability, channel loading status information, channel congestion control information and a gap between a potential success of the LBT procedure and a starting position of candidate resources.

8. The method of claim 1, wherein a self-defer mechanism is performed in a protection gap between a success of the LBT procedure and the transceiving of the SL packets.

9. The method of claim 8, wherein the self-defer mechanism is performed when SL packets are not ready and the LBT procedure succeeds, and wherein when SL packets become ready, a second LBT is performed immediately before the transceiving of the SL packets.

10. The method of claim 8, wherein the self-defer mechanism is performed when SL packets are ready and the LBT procedure succeeds and the protection gap is larger than a preconfigured threshold, and wherein a second LBT is performed immediately before the transceiving of the SL packets.

11. The method of claim 1, wherein a cyclic prefix (CP) extension (CPE) or a CPE and a timing advance (TA) is used to align a boundary between a success of the LBT procedure and the transceiving of the SL packets or occupy a protection gap between a success of the LBT procedure and the transceiving of the SL packets when the protection gap is smaller than or equal to a preconfigured threshold and SL packets are ready when the LBT succeeds.

12. The method of claim 1, wherein a channel occupancy time (COT) is initiated after a success of the LBT procedure.

13. The method of claim 12, wherein one or more reserved candidate resources within the COT are shared to one or more other UEs based on one or more reserved resource sharing factors comprising priority level, CAPC value, destination ID, cast type and channel/transmission type on the reserved resource.

14. The method of claim 12, wherein the SL resource selection procedure excludes one or more candidate resources in the COT based on predefined rules.

15. A user equipment (UE), comprising:
a transceiver that transmits and receives radio frequency (RF) signal in a wireless network;
a listen-before-talk (LBT) module that performs a LBT procedure to prepare for a UE sidelink (SL) transceiving in unlicensed frequency bands, wherein the LBT procedure determines channel selection with other coexisting wireless system in the unlicensed frequency bands;
a selection module that performs sidelink (SL) resource selection procedure, wherein the SL resource selection procedure selects candidate resources in the unlicensed frequency bands for an SL transceiving for the UE; and
a transceiving controller that transmits and receives SL packets on the selected candidate resources when both the SL resource selection procedure and the LBT procedure succeed.

16. The UE of claim 15, wherein the LBT procedure is performed before the SL resource selection procedure.

17. The UE of claim 15, wherein an LBT trigger time to start performing the LBT procedure is (pre-)configured or dynamically indicated.

18. The UE of claim 15, wherein a resource gap between a potential success of the LBT procedure and a starting position of candidate resources is (pre-)configured or dynamically indicated based on one or more resource gap factors comprising a channel status, a layer1 priority, a CAPC value, a channel/transmission type and an overbooking resource size.

19. The UE of claim 15, wherein a self-defer mechanism is performed in a protection gap between a success of the LBT procedure and the transceiving of the SL packets, and wherein the self-defer mechanism is one selecting from using a cyclic prefix (CP) extension to occupy the protection gap or align the boundary between a success of the LBT procedure and the transceiving of the SL packets, using a CP extension and a timing advance (TA) to occupy the protection gap or align the boundary between a success of the LBT procedure and the transceiving of the SL packets, and performing a second LBT immediately before the transceiving of the SL packets.

20. The UE of claim 15, wherein a channel occupancy time (COT) is initiated after a success of the LBT procedure, and wherein one or more reserved candidate resources within the COT is shared to another UE.
